(19) United States
(12) Patent Application Publication
(10) Pub. No.: US 2021/0321812 A1
(43) Pub. Date: Oct. 21, 2021

(54) HEATER ASSEMBLY FOR A COOKING DEVICE LID

(71) Applicant: LEXMARK INTERNATIONAL, INC., LEXINGTON, KY (US)

(72) Inventors: JERRY WAYNE SMITH, IRVINE, KY (US); RUSSELL EDWARD LUCAS, LEXINGTON, KY (US); CALVIN DALE MURPHY, GEORGETOWN, KY (US); PETER ALDEN BAYERLE, LEXINGTON, KY (US)

(21) Appl. No.: 17/151,891

(22) Filed: Jan. 19, 2021

Related U.S. Application Data
(60) Provisional application No. 63/013,164, filed on Apr. 21, 2020.

(51) Int. Cl. A47J 27/00; H05B 3/14; A47J 36/04; H05B 3/26

(52) U.S. Cl. CPC A47J 27/004; H05B 3/141; A47J 27/02; H05B 3/265; A47J 36/04

(57) ABSTRACT

A cooking device according to one example embodiment includes a base having a cooking vessel for retaining food for cooking. A lid is movable relative to the base between an open position and a closed position. A heater assembly is positioned on the lid for supplying heat to a surface of the lid that covers the opening of the cooking vessel when the lid is in the closed position. The heater assembly includes a heater having a ceramic substrate. The ceramic substrate has at least one electrically resistive trace thick film printed on the ceramic substrate and at least one electrically conductive trace thick film printed on the ceramic substrate. The heater is configured to generate heat when an electric current is supplied to the at least one electrically resistive trace.

### CROSS REFERENCES TO RELATED APPLICATIONS

This application claims priority to United States Provisional Patent Application Ser. No. 63/013,164, filed Apr. 21, 2020, entitled “Modular Ceramic Heater Assemblies,” the content of which is hereby incorporated by reference in its entirety.

### BACKGROUND

### 1. Field of the Disclosure

The present disclosure relates to a heater assembly for a cooking device lid.

### 2. Description of the Related Art

Manufacturers of cooking devices, such as rice cookers and pressure cookers, are continually challenged to improve the performance of such devices. Some cooking devices include a heater assembly positioned to supply heat to a lid of the cooking device in order to reduce water condensation on the lid during cooking. Otherwise, accumulation of condensation could disrupt the food being cooked in such devices, including, for example, the consistency of the food, if significant amounts of condensation drip into the food being cooked. Typically, these heater assemblies include a wire heater, such as a nichrome wire, that generates heat when an electrical current is passed through the wire. The nichrome wire heater is typically positioned on a thermally conductive heating plate positioned within the lid of the cooking device. However, these heaters often suffer from relatively long warmup and cooldown times and relatively non-uniform heat distribution.

Accordingly, an improved heater assembly for a lid of a cooking device is desired.

### SUMMARY

A cooking device according to one example embodiment includes a base having a cooking vessel for retaining food for cooking. A lid is movable relative to the base between an open position and a closed position. In the open position, the lid exposes an opening of the cooking vessel for permitting addition or removal of food from the cooking vessel. In the closed position, the lid covers the opening of the cooking vessel for cooking. A heater assembly is positioned on the lid for supplying heat to a surface of the lid that covers the opening of the cooking vessel when the lid is in the closed position. The heater assembly includes a heater having a ceramic substrate. The ceramic substrate has at least one electrically resistive trace thick film printed on the ceramic substrate and at least one electrically conductive trace thick film printed on the ceramic substrate. The heater is configured to generate heat when an electric current is supplied to the at least one electrically resistive trace.

A cooking device according to another example embodiment includes a base having a cooking vessel for retaining food for cooking. A lid is movable relative to the base between an open position and a closed position. In the open position, the lid exposes an opening of the cooking vessel for permitting addition or removal of food from the cooking vessel. In the closed position, the lid covers the opening of the cooking vessel for cooking. A thermally conductive heating plate is positioned within the lid. A heater is positioned on the heating plate. The heater includes a ceramic substrate and an electrically resistive trace positioned on the ceramic substrate. The heater is configured to generate heat when an electric current is supplied to the electrically resistive trace. The heating plate is positioned to transfer heat generated by the heater to a surface of the lid that covers the opening of the cooking vessel when the lid is in the closed position.

A cooking device according to another example embodiment includes a base having a cooking vessel for retaining food for cooking. A lid is movable relative to the base between an open position and a closed position. In the open position, the lid exposes an opening of the cooking vessel for permitting addition or removal of food from the cooking vessel. In the closed position, the lid covers the opening of the cooking vessel for cooking. A thermally conductive heating plate is positioned within the lid. A plurality of modular heaters are positioned on the heating plate. Each of the plurality of modular heaters includes a ceramic substrate and an electrically resistive trace positioned on the ceramic substrate. Each of the plurality of modular heaters is configured to generate heat when an electric current is supplied to the electrically resistive trace. The heating plate is positioned to transfer heat generated by the plurality of modular heaters to a surface of the lid that covers the opening of the cooking vessel when the lid is in the closed position.

### BRIEF DESCRIPTION OF THE DRAWINGS

The accompanying drawings incorporated in and forming a part of the specification illustrate several aspects of the present disclosure and together with the description serve to explain the principles of the present disclosure.

FIG. 1 is a perspective view of a cooking device according to one example embodiment.

FIG. 2 is a perspective view of the cooking device shown in FIG. 1 with a lid of the cooking device in an open position according to one example embodiment.

FIG. 3 is a schematic diagram of the cooking device shown in FIGS. 1 and 2 according to one example embodiment.

FIG. 4 is a perspective view of the lid of the cooking device with an inner lid exploded from a lid housing according to one example embodiment.

FIG. 5 is a schematic view of a heater assembly of the lid of the cooking device according to a first example embodiment.

FIG. 6 is a plan view of a heater of the heater assembly of the lid of the cooking device according to a first example embodiment.

FIG. 7 is a schematic view of a heater assembly of the lid of the cooking device according to a second example embodiment.

FIG. 8 is a schematic view of a heater assembly of the lid of the cooking device according to a third example embodiment.

FIG. 9 is a plan view of a heater of the heater assembly of the lid of the cooking device according to a second example embodiment.

FIG. 10 is a plan view of a heater assembly of the lid of the cooking device according to a fourth example embodiment.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

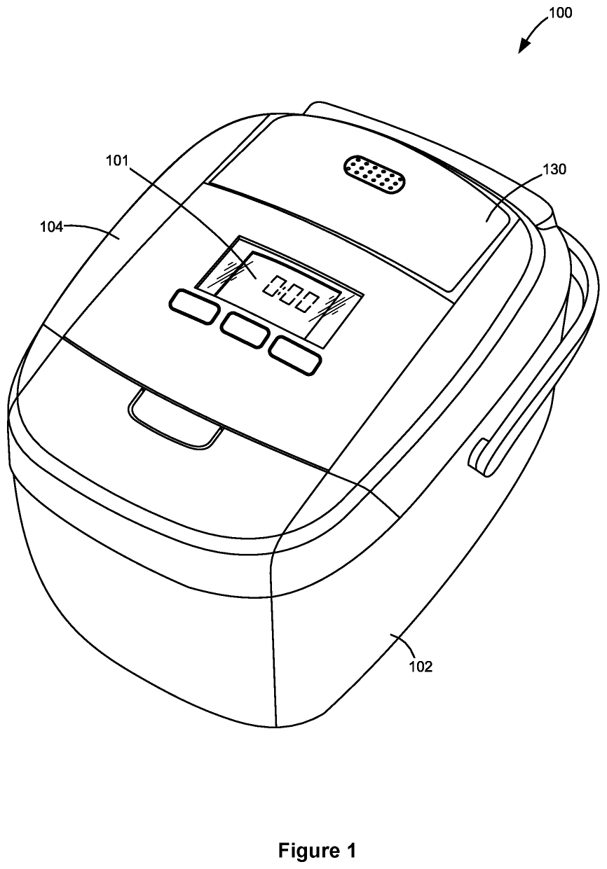

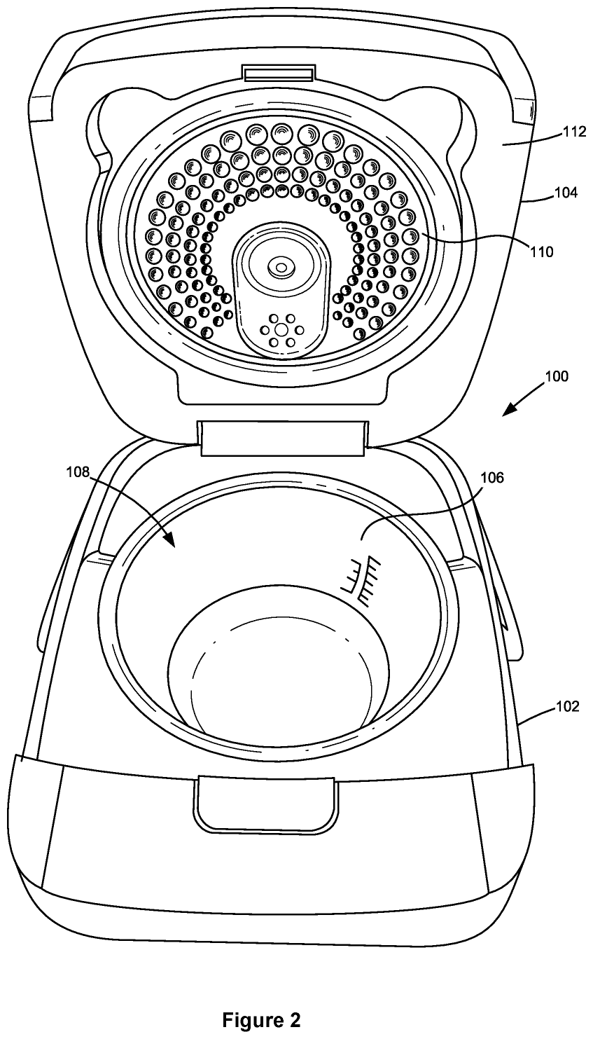

Referring now to the drawings and particularly to FIGS. 1 and 2, a cooking device 100 is shown according to one example embodiment. Cooking device 100 includes, for example, a rice cooker, pressure cooker, steam cooker, or other cooking device. In some embodiments, cooking device 100 includes an integrated lid for enclosing a cooking vessel of the cooking device during operation and a heating assembly for heating the lid, e.g., to reduce water condensation on the lid, as discussed in greater detail below.

A user interface 101 may be positioned on an exterior portion of cooking device 100 in order to permit a user to control the operation of cooking device 100. User interface 101 may include any suitable combination of, for example, one or more digital or mechanical dials, knobs, buttons, etc. for receiving input from a user. User interface 101 may include one or more displays, indicators, audio devices, haptic devices, etc. for providing information to a user.

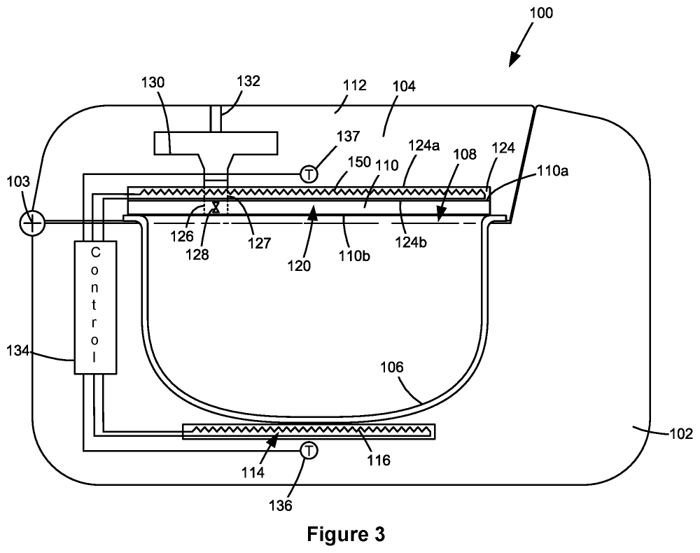

Cooking device 100 includes a base 102 and a lid 104. In the embodiment illustrated, lid 104 is movably attached to base 102, e.g., pivotally attached to base 102 about a pivot axis 103 (FIG. 3). In this embodiment, base 102 and lid 104 form an integrated assembly such that lid 104 is not freely separable from base 102. A cooking vessel 106 positioned on or in base 102 is configured to retain food for cooking by cooking device 100. Cooking vessel 106 may be separable from base 102 (e.g., to permit cleaning of cooking vessel 106) or formed integrally with base 102. Cooking vessel 106 is generally a container (e.g., a bowl) in which food to be cooked is contained. Cooking vessel 106 may be composed of, for example, a metal having high thermal conductivity, such as stainless steel, aluminum, copper or brass.

Lid 104 is movable relative to base 102 between a closed position shown in FIG. 1 and an open position shown in FIG. 2. When lid 104 is in the open position relative to base 102 as shown in FIG. 2, lid 104 is positioned to expose an opening 108 of cooking vessel 106 to permit the addition or removal of food in cooking vessel 106. When lid 104 is in the closed position relative to base 102 as shown in FIG. 1, lid 104 is positioned to cover opening 108 of cooking vessel 106. For example, when lid 104 is in the closed position, lid 104 may seal against a perimeter of opening 108 of cooking vessel 106 in order to permit pressurized (i.e., greater than atmospheric pressure) cooking within cooking vessel 106 if desired. In the embodiment illustrated, lid 104 includes an inner lid 110 attached to a housing 112 of lid 104 as shown in FIG. 2. In this embodiment, inner lid 110 covers opening 108 of cooking vessel when lid 104 is in the closed position. Inner lid 110 (e.g., including a gasket formed on or attached to inner lid 110) may seal against a perimeter of opening 108 of cooking vessel 106 when lid 104 is in the closed position. Inner lid 110 may be separable from housing 112, e.g., to permit cleaning of inner lid 110.

With reference to FIG. 3, cooking device 100 is shown schematically with lid 104 in the closed position relative to base 102 with inner lid 110 covering opening 108 of cooking vessel 106. Cooking device 100 includes a heater assembly 114 positioned in base 102. Heater assembly 114 is positioned to supply heat to cooking vessel 106 to cook food in cooking vessel 106 during operation of cooking device 100. Heater assembly 114 may include one or more resistive heaters 116 that generate heat when an electrical current is passed through an electrically resistive material.

Cooking device 100 also includes a heater assembly 120 positioned in lid 104. Heater assembly 120 is positioned to supply heat to inner lid 110 during cooking in order to reduce the condensation of water on inner lid 110 during cooking. In the embodiment illustrated, heater assembly 120 includes one or more heaters 150, such as a plurality of modular heaters 150, positioned on a heating plate 124 that is positioned against (or in close proximity to) an inner surface 110a of inner lid 110 that faces away from cooking vessel 106. Heating plate 124 is composed of a thermally conductive material, such as, for example, stainless steel, aluminum, copper or brass, in order to permit efficient heat transfer from heater(s) 150 to inner lid 110. In some embodiments, aluminum is advantageous due to its relatively high thermal conductivity and relatively low cost. Aluminum that has been hot forged into a desired shape is often preferable to cast aluminum due to the higher thermal conductivity of forged aluminum. Inner lid 110 may also be composed of a thermally conductive material, such as, for example, stainless steel, aluminum (e.g., forged aluminum), copper or brass.

Inner lid 110 and heating plate 124 may include one or more aligned vents 126, 127 therethrough that permit steam, e.g., formed from water in cooking vessel 106 heated by heater assembly 114 or from condensation on inner lid 110 heated by heater assembly 120, to exit cooking vessel 106 during operation of cooking device 100. One or both vents 126, 127 may include a valve 128 that selectively regulates the pressure within cooking vessel 106 during operation by restricting the passage of air (including steam) through vents 126, 127. Valve(s) 128 may include any suitable type, such as, for example, one or more spring-loaded valves, float valves, ball valves, solenoid-actuated valves, check valves, reed valves, etc. Alternatively, inner lid 110 and heating plate 124 may include one or more small, restrictive air channels, such as vents 126, 127, that permit moisture to vent from cooking vessel 106 during operation of cooking device 100.

Lid 104 may include a cup 130 or other vessel for collecting water condensation from steam that passes through vents 126, 127 of inner lid 110 and heating plate 124. Cup 130 may be removably mounted on lid 104 as shown in FIG. 1 in order to allow a user to empty water accumulating in cup 130. Housing 112 of lid 104 may include an additional vent 132 that permits air (including steam) released from cooking vessel 106 through vents 126, 127 to exit lid 104.

Cooking device 100 includes control circuitry 134 configured to control heater assemblies 114, 120 by selectively opening or closing respective circuits supplying electrical current to each heater assembly 114, 120. Control circuitry 134 may include one or more switches, such as, for example, one or more mechanical switches, electronic switches, relays or other switching devices, for selectively opening and closing respective circuits supplying electrical current to heater assemblies 114, 120. Open loop or, preferably, closed loop control may be utilized as desired. In the embodiment illustrated, each heater assembly 114, 120 includes a temperature sensor 136, 137, such as a thermostat or thermistor, permitting closed loop control of heater assemblies 114, 120 by control circuitry 134. Control circuitry 134 may include a microprocessor, a microcontroller, an application-specific integrated circuit, and/or other form of integrated circuit. In some embodiments, control circuitry 134 may include power control logic and/or other circuitries for controlling the amount of power delivered to each heater assembly 114, 120 to permit adjustment of the amount of heat generated by each heater assembly 114, 120 within a desired range. Control circuitry 134 may be configured to control heater assemblies 114, 120 independent of each other or jointly as desired.

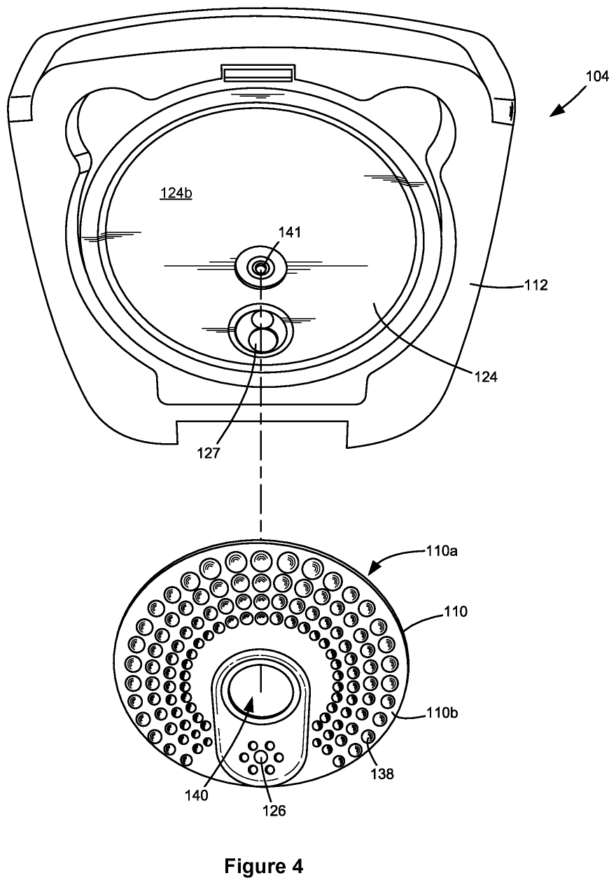

FIG. 4 shows lid 104 of cooking device 100 with inner lid 110 separated from housing 112 in order to show heating plate 124 positioned within housing 112. Vents 126, 127 on inner lid 110 and heating plate 124 are shown according to one example embodiment in FIG. 4. In the embodiment illustrated, an outer surface 110b of inner lid 110 that faces away from heating plate 124 and toward cooking vessel 106 includes a contoured surface, such as, for example, a pattern of concave recesses or dimples 138, that helps reduce water condensation on outer surface 110b of inner lid 110. In the embodiment illustrated, inner lid 110 includes a mounting hole 140 that extends through a central portion of inner lid 110. Mounting hole 140 receives a corresponding boss 141 protruding from an outer surface 124b of heating plate 124 that faces toward inner lid 110. Boss 141 of heating plate 124 and mounting hole 140 of inner lid 110 provide a friction fit engagement between inner lid 110 and heating plate 124 that allows a user to manually remove inner lid 110 from housing 112 of lid 104, for example, to clean inner lid 110. However, inner lid 110 may be mounted to lid 104, including to heating plate 124, by any suitable means.

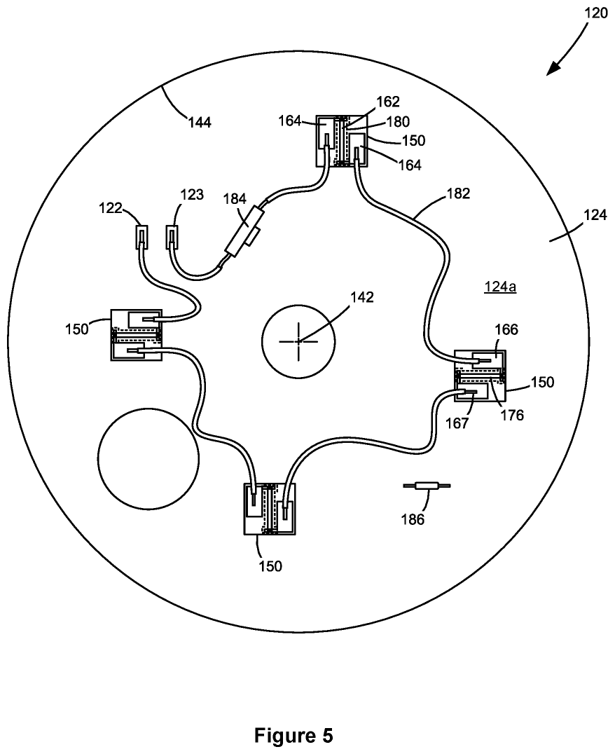

FIG. 5 shows heater assembly 120 of cooking device 100 according to one example embodiment. In the example embodiment illustrated, heater assembly 120 is positioned on an inner surface 124a of heating plate 124 that faces away from inner lid 110. Heat transfer from each heater 150 to heating plate 124 may be improved by attaching each heater 150 to heating plate 124 using a thermally conductive, high temperature resistant double-sided tape or a thermally conductive adhesive or gap filler positioned between an inner face of each heater 150 and inner surface 124a of heating plate 124. Heat generated by heater assembly 120 passes from heating plate 124 to inner lid 110 in order to reduce the condensation of water on outer surface 110b of inner lid 110 during cooking. In other embodiments, heater assembly 120 may be positioned on outer surface 124b of heating plate 124, on inner surface 110a of inner lid 110, or in another location that permits efficient heat transfer from heater assembly 120 to inner lid 110.

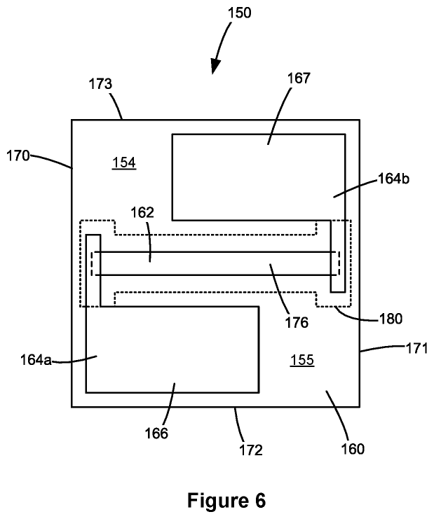

With reference to FIGS. 5 and 6, heater assembly 120 includes one or more heaters 150 positioned on heating plate 124. Each heater 150 has an inner face that faces toward the surface that heater 150 is positioned against (e.g., inner surface 124a of heating plate 124 in the example embodiment illustrated) and an outer face 154 that faces away from the surface that heater 150 is positioned against. As discussed in greater detail below, each heater 150 includes a ceramic substrate 160 (e.g., commercially available 96% aluminum oxide ceramic) having a series of one or more electrically resistive traces 162 and electrically conductive traces 164 positioned on ceramic substrate 160. Resistive trace(s) 162 include a suitable electrical resistor material such as, for example, silver palladium (e.g., blended 70/30 silver palladium). Heat is generated when an electrical current is passed through resistive trace(s) 162. Conductive traces 164 include a suitable electrical conductor material such as, for example, silver platinum. Conductive traces 164 provide electrical connections to and between resistive trace(s) 162. Conductive traces 164 also form a pair of terminals 166, 167 of each heater 150 for providing electrical connections to each heater 150.

FIG. 6 shows outer face 154 of heater 150 according to one example embodiment. In the embodiment illustrated, the inner face and outer face 154 of heater 150 are bordered by four sides or edges 170, 171, 172 and 173, each having a smaller surface area than the inner face and outer face 154 of heater 150. In this embodiment, the inner face and outer face 154 of heater 150 are square-shaped; however, other shapes may be used as desired (e.g., other polygons such as a rectangle). As discussed above, heater 150 includes one or more layers of a ceramic substrate 160. Ceramic substrate 160 includes an outer face 155 that is oriented toward outer face 154 of heater 150 and an inner face that is oriented toward the inner face of heater 150. Outer face 155 and the inner face of ceramic substrate 160 are positioned on exterior portions of ceramic substrate 160 such that if more than one layer of ceramic substrate 160 is used, outer face 155 and the inner face of ceramic substrate 160 are positioned on opposed external faces of ceramic substrate 160 rather than on interior or intermediate layers of ceramic substrate 160.

In the example embodiment illustrated, the inner face of heater 150 is formed by the inner face of ceramic substrate 160. In this embodiment, outer face 155 of ceramic substrate 160 includes a series of one or more electrically resistive traces 162 and electrically conductive traces 164 positioned thereon. In the embodiment illustrated, resistive traces 162 and conductive traces 164 are applied to ceramic substrate 160 by way of thick film printing. For example, resistive traces 162 may include a resistor paste having a thickness of 10-13 microns when applied to ceramic substrate 160, and conductive traces 164 may include a conductor paste having a thickness of 9-15 microns when applied to ceramic substrate 160. Resistive traces 162 form respective heating elements 176 of heater 150, and conductive traces 164 provide electrical connections to and between resistive traces 162 in order to supply an electrical current to each resistive trace 162 to generate heat.

In the example embodiment illustrated, heater 150 includes a single resistive trace 162 that extends from near a first edge 170 of heater 150 toward a second edge 171 of heater 150, substantially parallel to third and fourth edges 172, 173 of heater 150. In this embodiment, resistive trace 162 is positioned midway between edges 172, 173 of heater 150. A pair of conductive traces 164a, 164b each form a respective terminal 166, 167 of heater 150. In the example embodiment illustrated, conductive trace 164a directly contacts a first end of resistive trace 162 near edge 170 of heater 150, and conductive trace 164b directly contacts a second end of resistive trace 162 near edge 171 of heater 150. Conductive trace 164a includes a first segment that extends from the first end of resistive trace 162 toward edge 172 of heater 150, along edge 170 of heater 150. Conductive trace 164a also includes a second segment, which forms terminal 166 of heater 150, that extends from the first segment of conductive trace 164a toward edge 171 of heater 150, along edge 172 of heater 150, and parallel to resistive trace 162. Conductive trace 164b includes a first segment that extends from the second end of resistive trace 162 toward edge 173 of heater 150, along edge 171 of heater 150. Conductive trace 164b also includes a second segment, which forms terminal 167 of heater 150, that extends from the first segment of conductive trace 164b toward edge 170 of heater 150, along edge 173 of heater 150, and parallel to resistive trace 162. Portions of resistive trace 162 obscured beneath conductive traces 164a, 164b in FIGS. 5 and 6 are shown in dashed line. In this embodiment, current input to heater 150 at, for example, terminal 166 by way of conductive trace 164a passes from conductive trace 164a to resistive trace 162, and from resistive trace 162 to conductive trace 164b where it is output from heater 150 at terminal 167. Current input to heater 150 at terminal 167 travels in reverse along the same path.

In the embodiment illustrated, heater 150 includes one or more layers of printed glass 180 on outer face 155 of ceramic substrate 160. In the embodiment illustrated, glass 180 covers resistive trace 162 and portions of conductive traces 164 in order to electrically insulate such features to prevent electric shock or arcing. The borders of glass layer 180 are shown in dotted line in FIGS. 5 and 6. An overall thickness of glass 180 may range from, for example, 70-80 microns.

Each heater 150 may be constructed by way of thick film printing. For example, in one embodiment, resistive traces 162 are printed on fired (not green state) ceramic substrate 160, which includes selectively applying a paste containing resistor material to ceramic substrate 160 through a patterned mesh screen with a squeegee or the like. The printed resistor is then allowed to settle on ceramic substrate 160 at room temperature. The ceramic substrate 160 having the printed resistor is then heated at, for example, approximately 140-160 degrees Celsius for a total of approximately 30 minutes, including approximately 10-15 minutes at peak temperature and the remaining time ramping up to and down from the peak temperature, in order to dry the resistor paste and to temporarily fix resistive traces 162 in position. The ceramic substrate 160 having temporary resistive traces 162 is then heated at, for example, approximately 850 degrees Celsius for a total of approximately one hour, including approximately 10 minutes at peak temperature and the remaining time ramping up to and down from the peak temperature, in order to permanently fix resistive traces 162 in position. Conductive traces 164 are then printed on ceramic substrate 160, which includes selectively applying a paste containing conductor material in the same manner as the resistor material. The ceramic substrate 160 having the printed resistor and conductor is then allowed to settle, dried and fired in the same manner as discussed above with respect to resistive traces 162 in order to permanently fix conductive traces 164 in position. Glass layer(s) 180 are then printed in substantially the same manner as the resistors and conductors, including allowing the glass layer(s) 180 to settle as well as drying and firing the glass layer(s) 180. In one embodiment, glass layer(s) 180 are fired at a peak temperature of approximately 810 degrees Celsius, slightly lower than the resistors and conductors.

Thick film printing resistive traces 162 and conductive traces 164 on fired ceramic substrate 160 provides more uniform resistive and conductive traces in comparison with conventional ceramic heaters, which include resistive and conductive traces printed on green state ceramic. The improved uniformity of resistive traces 162 and conductive traces 164 provides more uniform heating across the inner face and outer face 154 of heater 150 as well as more predictable heating of heater 150.

While the example embodiment illustrated in FIGS. 5 and 6 includes resistive traces 162, and the heating elements 176 formed thereby, positioned on outer face 155 of ceramic substrate 160, in other embodiments, resistive traces 162, and the heating elements 176 formed thereby, may be positioned on the inner face of ceramic substrate 160 along with corresponding conductive traces as needed to establish electrical connections thereto. Similarly, terminals 166, 167 may be positioned on the inner face of ceramic substrate 160 as desired. Glass 180 may cover the resistive traces and conductive traces on outer face 155 and/or the inner face of ceramic substrate 160 as desired in order to electrically insulate such features.

With reference back to FIG. 5, in the example embodiment illustrated, heater assembly 120 includes four heaters 150 spaced from each other on inner surface 124a of heating plate 124. In the embodiment illustrated, heaters 150 are spaced from each other around a center 142 of heating plate 124 and are positioned between center 142 of heating plate 124 and an outer perimeter 144 of heating plate 124 so that heat generated by heaters 150 is distributed relatively evenly across heating plate 124. The number of heaters 150 and the placement of each heater 150 on heating plate 124 may be selected to minimize the temperature gradient on outer surface 110b of inner lid 110 where water condensates.

In the example embodiment illustrated, the heaters 150 of heater assembly 120 are connected to each other in series by insulated cables or wires 182, which contact respective terminals 166, 167 of heaters 150. Heaters 150 may also be connected in parallel as desired. Heaters 150 may also be connected to each other by other suitable electrical connectors (e.g., busbars, etc.) as desired. In the embodiment illustrated, cables/wires 182 electrically connect heaters 150 to a pair of terminals 122, 123 (e.g., pads or other forms of electrical contacts) that electrically connect heater assembly 120 to control circuitry 134 and a voltage source of cooking device 100.

In the example embodiment illustrated, heater assembly 120 includes a thermal fuse, switch or cutoff 184, e.g., a pellet-type thermal cutoff or a bimetal thermal cutoff, electrically connected in series with heaters 150 permitting thermal cutoff 184 to open the circuit formed by heaters 150 upon detection by thermal cutoff 184 of a temperature that exceeds a predetermined amount. In this manner, thermal cutoff 184 provides additional safety by preventing overheating of heater assembly 120.

In the example embodiment illustrated, heater assembly 120 also includes a thermostat or thermistor 186, e.g., a negative temperature coefficient thermistor, positioned on inner surface 124a of heating plate 124. Cables or wires may be connected to thermistor 186 in order to electrically connect thermistor 186 to, for example, control circuitry 134 that operates heater assembly 120 in order to provide closed loop control of heater assembly 120. In other embodiments, thermistor 186 may be positioned on one or more of heaters 150, or on another surface (e.g., inner surface 124a of heating plate 124) in close proximity to heating plate 124 or inner lid 110 in order to provide temperature feedback to control circuitry 134 to permit closed loop control of heater assembly 120. Further, while the example embodiment illustrated includes a thermostat or thermistor outside of the circuit formed by heaters 150, in other embodiments, a thermostat or thermistor may be electrically connected (e.g., in series) to the circuit formed by heaters 150.

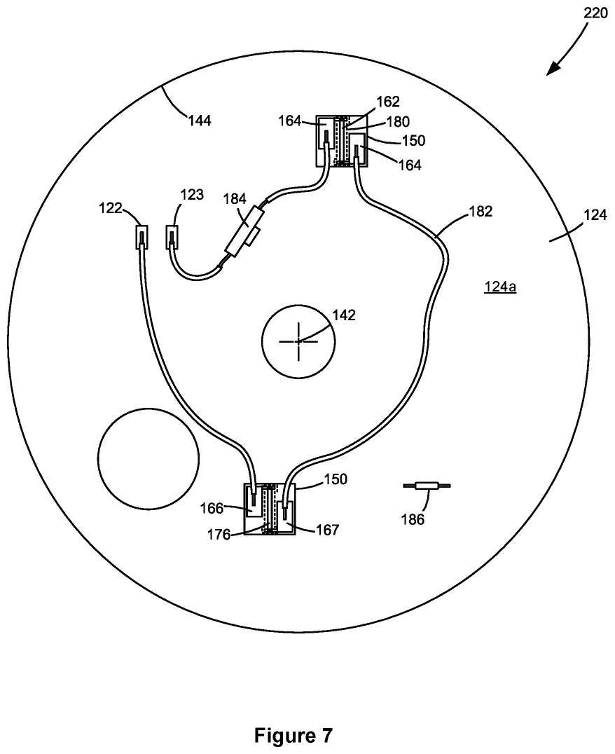

While the example embodiment shown in FIG. 5 includes a heater assembly 120 having four heaters 150 spaced from each other on inner surface 124a of heating plate 124, more or fewer than four heaters 150 may be used as desired to supply heat to inner lid 110 for reducing condensation of water on inner lid 110 during cooking. For example, FIG. 7 shows a heater assembly 220 according to another example embodiment having a pair of heaters 150 positioned on inner surface 124a of heating plate 124. As in the embodiment discussed above, heaters 150 are spaced from each other on inner surface 124a of heating plate 124, and heaters 150 are positioned between center 142 of heating plate 124 and outer perimeter 144 of heating plate 124 to distribute heat generated by heaters 150 across heating plate 124. As discussed above, the number of heaters 150 and the positioning of heaters 150 may be tailored to minimize the temperature gradient on outer surface 110b of inner lid 110.

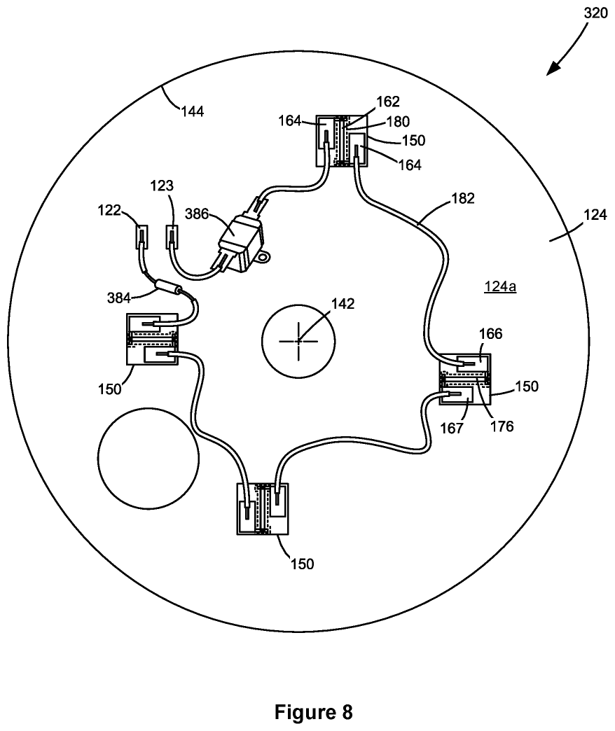

FIG. 8 shows a heater assembly 320 according to another example embodiment. In this embodiment, heater assembly 320 includes a pellet-type thermal cutoff 384 electrically connected in series with heaters 150 permitting thermal cutoff 384 to open the circuit formed by heaters 150 upon detection by thermal cutoff 384 of a temperature that exceeds a predetermined amount. Heater assembly 320 also includes a thermostat or thermistor 386, e.g., a bimetal thermostat, electrically connected in series with heaters 150 in order to provide closed loop control of heater assembly 320.

Heaters 150 illustrated and discussed above with respect to FIGS. 5-8 are merely an example, and other configurations may be used as desired. For example, the heaters of the present disclosure may include resistive and conductive traces in many different patterns, layouts, geometries, shapes, positions, sizes and configurations as desired, including resistive traces on an outer face of each heater, an inner face of each heater and/or an intermediate layer of the ceramic substrate of each heater. Other components (e.g., a thermistor, thermostat, thermal cutoff, thermal fuse and/or a thermal switch) may be positioned on or against a face of each heater as desired. As discussed above, ceramic substrates of the heater may be provided in a single layer or multiple layers, and various shapes (e.g., rectangular, square or other polygonal faces) and sizes of ceramic substrates may be used as desired. Curvilinear shapes may be used as well but are typically more expensive to manufacture. Printed glass may be used as desired on the outer face and/or the inner face of each heater to provide electrical insulation.

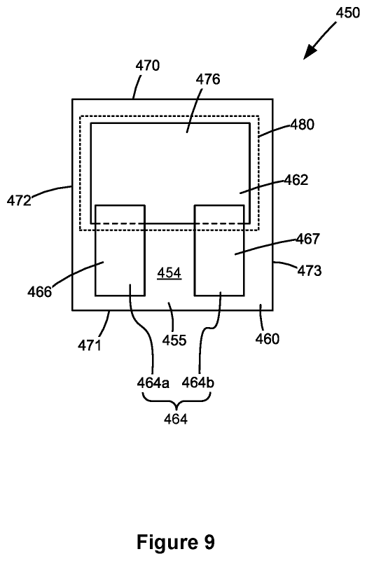

FIG. 9 shows a modular heater 450 for use with the heater assembly of lid 104, such as heater assemblies 120, 220, 320, according to another example embodiment. FIG. 9 shows an outer face 454 of heater 450. In the embodiment illustrated, an inner face and outer face 454 of heater 450 are bordered by four sides or edges 470, 471, 472 and 473, each having a smaller surface area than the inner face and outer face 454 of heater 450. In this embodiment, the inner face and outer face 454 of heater 450 are square-shaped; however, other shapes may be used as discussed above. Like heater 150 discussed above, heater 450 includes one or more layers of a ceramic substrate 460. In the example embodiment illustrated, the inner face of heater 150 is formed by an inner face of ceramic substrate 460. In this embodiment, an outer face 455 of ceramic substrate 460 includes an electrically resistive trace 462 and a pair of electrically conductive traces 464 positioned thereon. As discussed above, resistive trace 462 forms a respective heating element 476 of heater 450, and conductive traces 464 provide electrical connections to resistive trace 462 in order to supply an electrical current to resistive trace 462 to generate heat.

In the example embodiment illustrated, resistive trace 462 covers most of one half (a top half in the orientation illustrated in FIG. 9) of outer face 455 of ceramic substrate 460 along edge 470 of heater 450. A pair of conductive traces 464a, 464b each form a respective terminal 466, 467 of heater 450. In the example embodiment illustrated, conductive trace 464a directly contacts a first portion of resistive trace 462 near edge 472 of heater 450, and conductive trace 464b directly contacts a second portion of resistive trace 462 near edge 473 of heater 450. Conductive traces 464a, 464b extend parallel to each other from resistive trace 462 toward edge 471 of heater 450. Portions of resistive trace 462 obscured beneath conductive traces 464a, 464b in FIG. 9 are shown in dashed line. In this embodiment, current input to heater 450 at, for example, terminal 466 by way of conductive trace 464a passes from conductive trace 464a to resistive trace 462, and from resistive trace 462 to conductive trace 464b where it is output from heater 450 at terminal 467. Current input to heater 450 at terminal 467 travels in reverse along the same path.

In the embodiment illustrated, heater 450 includes one or more layers of printed glass 480 on outer face 455 of ceramic substrate 460. In the embodiment illustrated, glass 480 covers resistive trace 462 and portions of conductive traces 464 in order to electrically insulate such features as discussed above. The borders of glass layer 480 are shown in dotted line in FIG. 9.

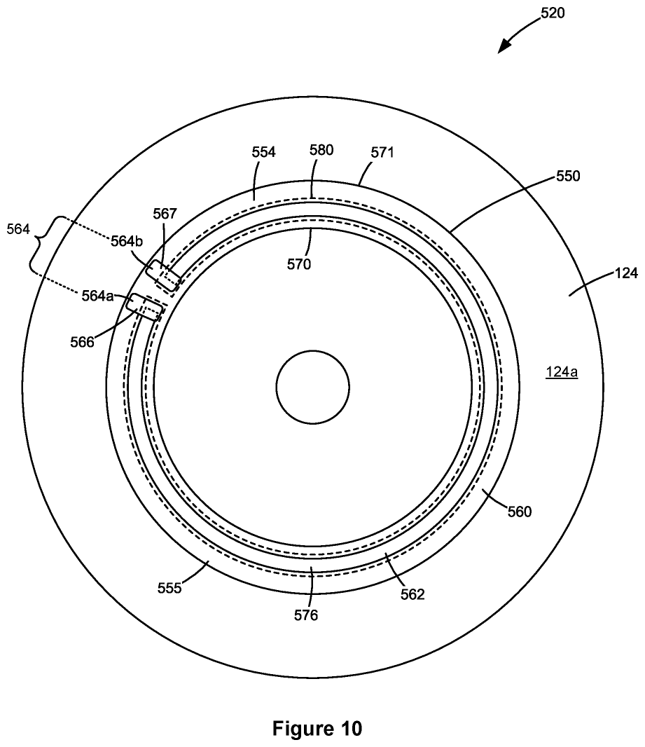

FIG. 10 shows a heater assembly 520 according to another example embodiment including a heater 550 positioned on, for example, inner surface 124a of heating plate 124. In this embodiment, heater 550 has an inner face that faces toward the surface that heater 550 is positioned against (e.g., inner surface 124a of heating plate 124) and an outer face 554 that faces away from the surface that heater 550 is positioned against. In the embodiment illustrated, heater 550 is in the shape of a circular ring, defined by an inner circumferential edge 570 and an outer circumferential edge 571. Like heaters 150, 450 discussed above, heater 550 includes one or more layers of a ceramic substrate 560. In the example embodiment illustrated, the inner face of heater 550 is formed by an inner face of ceramic substrate 560. In this embodiment, an outer face 555 of ceramic substrate 560 includes an electrically resistive trace 562 and a pair of electrically conductive traces 564 positioned thereon. As discussed above, resistive trace 562 forms a respective heating element 576 of heater 550, and conductive traces 564 provide electrical connections to resistive trace 562 in order to supply an electrical current to resistive trace 562 to generate heat.

In the example embodiment illustrated, resistive trace 562 is positioned on outer face 555 of ceramic substrate 560. In this embodiment, resistive trace 562 extends in a circular pattern from a first conductive trace 564a to a second conductive trace 564b, forming a partial circle (e.g., a nearly complete circle as illustrated) between conductive traces 564a, 564b. In the embodiment illustrated, resistive trace 562 makes a single pass along outer face 555 of ceramic substrate 560 between conductive traces 564a, 564b, but resistive trace 562 may make multiple passes along outer face 555 of ceramic substrate 560 in other embodiments. Similarly, as discussed above, more than one resistive trace 562 may be used as desired. Conductive traces 564a, 564b each form a respective terminal 566, 567 of heater 550. Portions of resistive trace 562 obscured beneath conductive traces 564a, 564b in FIG. 10 are shown in dotted line. In this embodiment, current input to heater 550 at, for example, terminal 566 by way of conductive trace 564a passes from conductive trace 564a to resistive trace 562, and from resistive trace 562 to conductive trace 564b where it is output from heater 550 at terminal 567. Current input to heater 550 at terminal 567 travels in reverse along the same path.

In the embodiment illustrated, heater 550 includes one or more layers of printed glass 580 on outer face 555 of ceramic substrate 560. In the embodiment illustrated, glass 580 covers resistive trace 562 and portions of conductive traces 564 in order to electrically insulate such features as discussed above. The borders of glass layer 580 are shown in dashed line in FIG. 10.

While the example embodiments illustrated include a heater assembly positioned on an inner surface 124a of a heating plate 124, as discussed above, a heater assembly for reducing water condensation on the lid of cooking device 100 may be positioned in other suitable locations for providing heat to the lid, such as an outer surface 124b of heating plate 124 or an inner surface 110a of an inner lid 110. Further, while the embodiments illustrated include heater assemblies 120, 220, 320, 520 according to several different examples, it will be appreciated that the number of heaters used and the arrangement of such heaters to distribute heat to the lid of cooking device 100 may vary as desired. Similarly, the individual heaters used may include many different configurations including resistive and conductive traces in many different patterns, layouts, geometries, shapes, positions, sizes and configurations as desired, including resistive traces on an outer face of each heater, an inner face of each heater and/or an intermediate layer of the ceramic substrate of each heater. Further, one or more temperature sensors, such as thermistors and/or thermostats, may be used as desired to provide closed loop control of the heater assembly. Similarly, one or more thermal fuses, switches or cutoffs may be used as desired to prevent overheating. Temperature sensors and/or thermal fuses, switches or cutoffs may be positioned on or against a face of one or more of the heaters of the heater assembly and/or on or against heating plate 124 or another surface on which the heater(s) are positioned as desired.

The heaters of the present disclosure are preferably produced in an array for cost efficiency, for example, with each heater in a particular array having substantially the same construction. Preferably, each array of heaters is separated into individual heaters after the construction of all heaters in the array is completed, including firing of all components and any applicable finishing operations. In some embodiments, individual heaters are separated from the array by way of fiber laser scribing. Fiber laser scribing tends to provide a more uniform singulation surface having fewer microcracks along the separated edge in comparison with conventional carbon dioxide laser scribing. In some embodiments, the ceramic substrate of each heater is tape cast and laminated in two green state layers that are oriented such that they have opposing, concave camber when pressed together, dried, and fired.

In order to minimize cost and manufacturing complexity, it is preferable to standardize the sizes and shapes of the heater panels and the individual heaters in order to produce arrays of modular heaters. As an example, panels may be prepared in rectangular or square shapes, such as 2″ by 2″ or 4″ by 4″ square panels or larger 165 mm by 285 mm rectangular panels. The thickness of each layer of the ceramic substrate may range from 0.3 mm to 2 mm. For example, commercially available ceramic substrate thicknesses include 0.3 mm, 0.635 mm, 1 mm, 1.27 mm, 1.5 mm, and 2 mm. Another approach is to construct the heaters in non-standard or custom sizes and shapes to match the heating area required in a particular application. However, for larger heating applications, this approach generally increases the manufacturing cost and material cost of the heaters significantly in comparison with constructing modular heaters in standard sizes and shapes.

The present disclosure provides ceramic heaters having a low thermal mass in comparison with conventional ceramic heaters. In some embodiments, thick film printed resistive traces on an exterior face (outer or inner) of the ceramic substrate provides reduced thermal mass in comparison with resistive traces positioned internally between multiple sheets of ceramic. In some embodiments, thick film printing the resistive and conductive traces on fired ceramic substrate provides more uniform and predictable resistive and conductive traces in comparison with resistive and conductive traces printed on green state ceramic due to relatively large variations in the amount of shrinkage of the ceramic during firing of green state ceramic. The low thermal mass of the ceramic heaters of the present disclosure allows the heater(s), in some embodiments, to heat to an effective temperature for use in a matter of seconds (e.g., less than 5 seconds, or less than 20seconds), significantly faster than conventional heaters. The low thermal mass of the ceramic heaters of the present disclosure also allows the heater(s), in some embodiments, to cool to a safe temperature after use in a matter of seconds (e.g., less than 5 seconds, or less than 20 seconds), again, significantly faster than conventional heaters. Further, embodiments of the ceramic heaters of the present disclosure operate at a more precise and more uniform temperature than conventional heaters because of the relatively uniform thick film printed resistive and conductive traces. The low thermal mass of the ceramic heaters and improved temperature control permit greater energy efficiency in comparison with conventional heaters.

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A cooking device, comprising:
a base having a cooking vessel for retaining food for cooking;
a lid movable relative to the base between an open position and a closed position, in the open position the lid exposes an opening of the cooking vessel for permitting addition or removal of food from the cooking vessel, in the closed position the lid covers the opening of the cooking vessel for cooking; and
a heater assembly positioned on the lid for supplying heat to a surface of the lid that covers the opening of the cooking vessel when the lid is in the closed position, the heater assembly includes a heater having a ceramic substrate, the ceramic substrate has at least one electrically resistive trace thick film printed on the ceramic substrate and at least one electrically conductive trace thick film printed on the ceramic substrate, the heater is configured to generate heat when an electric current is supplied to the at least one electrically resistive trace.

2. The cooking device of claim 1, wherein the at least one electrically resistive trace is positioned on an exterior surface of the ceramic substrate.

3. The cooking device of claim 2, wherein the heater includes a glass layer covering the at least one electrically resistive trace for electrically insulating the at least one electrically resistive trace.

4. The cooking device of claim 1, further comprising a thermally conductive heating plate positioned within the lid, wherein the heater is positioned on the heating plate, and the heating plate is positioned to transfer heat generated by the heater to the surface of the lid that covers the opening of the cooking vessel when the lid is in the closed position.

5. The cooking device of claim 4, wherein the heater is positioned on an inner surface of the heating plate that faces away from the cooking vessel when the lid is in the closed position.

6. The cooking device of claim 4, wherein the at least one electrically resistive trace is positioned on an exterior surface of the ceramic substrate that faces away from the heating plate.

7. A cooking device, comprising:
a base having a cooking vessel for retaining food for cooking;
a lid movable relative to the base between an open position and a closed position, in the open position the lid exposes an opening of the cooking vessel for permitting addition or removal of food from the cooking vessel, in the closed position the lid covers the opening of the cooking vessel for cooking;
a thermally conductive heating plate positioned within the lid; and
a heater positioned on the heating plate, the heater includes a ceramic substrate and an electrically resistive trace positioned on the ceramic substrate, the heater is configured to generate heat when an electric current is supplied to the electrically resistive trace, the heating plate is positioned to transfer heat generated by the heater to a surface of the lid that covers the opening of the cooking vessel when the lid is in the closed position.

8. The cooking device of claim 7, wherein the electrically resistive trace is thick film printed on an exterior surface of the ceramic substrate.

9. The cooking device of claim 8, wherein the heater includes a glass layer covering the electrically resistive trace for electrically insulating the electrically resistive trace.

10. The cooking device of claim 7, wherein the heater is positioned on an inner surface of the heating plate that faces away from the cooking vessel when the lid is in the closed position.

11. The cooking device of claim 7, wherein the electrically resistive trace is positioned on an exterior surface of the ceramic substrate that faces away from the heating plate.

12. A cooking device, comprising:
a base having a cooking vessel for retaining food for cooking;
a lid movable relative to the base between an open position and a closed position, in the open position the lid exposes an opening of the cooking vessel for permitting addition or removal of food from the cooking vessel, in the closed position the lid covers the opening of the cooking vessel for cooking;
a thermally conductive heating plate positioned within the lid; and
a plurality of modular heaters positioned on the heating plate, each of the plurality of modular heaters includes a ceramic substrate and an electrically resistive trace positioned on the ceramic substrate, each of the plurality of modular heaters is configured to generate heat when an electric current is supplied to the electrically resistive trace, the heating plate is positioned to transfer heat generated by the plurality of modular heaters to a surface of the lid that covers the opening of the cooking vessel when the lid is in the closed position.

13. The cooking device of claim 12, wherein each of the plurality of modular heaters includes the electrically resistive trace thick film printed on an exterior surface of the ceramic substrate.

14. The cooking device of claim 13, wherein each of the plurality of modular heaters includes a glass layer covering the electrically resistive trace for electrically insulating the electrically resistive trace.

15. The cooking device of claim 12, wherein each of the plurality of modular heaters is positioned on an inner surface of the heating plate that faces away from the cooking vessel when the lid is in the closed position.

16. The cooking device of claim 12, wherein each of the plurality of modular heaters includes the electrically resistive trace positioned on an exterior surface of the ceramic substrate that faces away from the heating plate.

17. The cooking device of claim 12, wherein the plurality of modular heaters are spaced from each other on a surface of the heating plate.

18. The cooking device of claim 17, wherein the plurality of modular heaters are spaced around a center of the heating plate.

19. The cooking device of claim 12, wherein the plurality of modular heaters are electrically connected in series.

20. The cooking device of claim 12, wherein the plurality of modular heaters are arranged to minimize a temperature gradient on the surface of the lid that covers the opening of the cooking vessel when the lid is in the closed position.
